(19) United States
(12) Patent Application Publication
(10) Pub. No.: US 2019/0009587 A1
(43) Pub. Date: Jan. 10, 2019

(54) SLOT INTERFACE FIXEDLY COUPLED TO FRAME

(71) Applicant: Hewlett-Packard Development Company, L.P., Houston, TX (US)

(72) Inventors: Danny Barker, Vancouver, WA (US); Kevin Lo, Vancouver, WA (US)

(21) Appl. No.: 16/064,206

(22) PCT Filed: Apr. 15, 2016
(86) PCT No.: PCT/US2016/027731

§ 371 Date: Jun. 20, 2018

(51) Int. Cl. B41J 29/02

(52) U.S. Cl. CPC B41J 29/026

(57) ABSTRACT

In an example, a system may include a first device module and a second device module coupled by a slot interface and a bracket. An example first device module may include a frame and the slot interface fixedly coupled to the frame. An example slot interface includes a guide member to define part of a channel. An example bracket may have a portion of the bracket to slidably fit in the channel of the slot interface. In an example system, a fastener couples the bracket to the frame of a second device module.

### BACKGROUND

Imaging devices, such as multifunction peripheral devices, may be designed in a modular fashion, such that various components (such as a scanner module, a finisher module, a cart, a stand, etc.) are manufactured independently. This approach may improve manufacturing line efficiency and flexibility to satisfy unanticipated market demand for certain product configurations.

### BRIEF DESCRIPTION OF THE DRAWINGS

FIG. 1 is a block diagram of an example imaging device module.

FIG. 2 is a perspective view of an example system of assembled example imaging device modules.

FIGS. 3-5 are perspective views of example assembly states of an example system.

FIG. 6 is an exploded view of example components of an example system of example imaging device modules.

FIGS. 7-9 are flow diagrams depicting example methods of connecting a first imaging device module to a second imaging device module.

### DETAILED DESCRIPTION

In the following description and figures, some example implementations of imaging device modules, systems, and/or methods of connecting imaging device modules are described. As used herein, a device module is a physical section of an imaging system. For example, the components of a device or related-devices may be compartmentalized based on functionality provided by that set of components. In this manner, a customer may be able to select a certain set of features and receive a customized system by attaching the modules of the selected features together.

In examples described herein, an imaging system may include device modules that provide a functionality (or multiple functionalities). Imaging systems with modular designs generally include a base device module and a component device module, such as a scanner device module or a cart module. A base device module may include a print device to print content on a physical medium (e.g., paper or a layer of powder-based build material, etc.) with a printing fluid (e.g., ink) or toner. In the case of printing on a layer of powder-based build material, the printing device may utilize the deposition of printing fluids in a layer-wise additive manufacturing process. A printing device may utilize suitable printing consumables, such as ink, toner, fluids or powders, or other raw materials for printing. In some examples, a printing device may be a three-dimensional (3D) printing device. An example of printing fluid is ink ejectable from a printhead. A scanner device module may include components used to perform a scanning operation on target media. An automatic document feeder (ADF) device module may include components to facilitate automatic feeding of the media into the imaging system. A finisher device module may include components used to receive media and perform finishing operations, such as stapling, collating, etc. A cart device module may include components such as structural supports and wheels to allow the imaging system to be mobile.

Structural integrity and assembly time are factors that may be considered when determining a type of attachment between imaging modules. For example, the device modules may be designed such that the method of attachment is simple, robust, and does not compromise product aesthetics. In another example such as when the components are manufactured and shipped independently for assembly elsewhere, the components may be designed with shipping density in mind.

Various examples described below relate to an attachment approach using a slot interface on a first device module to receive a bracket that attaches to a second device module. By inserting a bracket into a slot interface on a module of the assembly and then fastened in place, a load placed on the module may be carried through the point of connection made by the bracket and slot interface combination which may, for example, enable structural integrity of the system via the rigid attachment approach.

A “moment”, as used herein, refers to a force (e.g., a load) with reference to an object. For example, a moment may be a load induced in a structural element of an imaging device module by an external force. The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus.

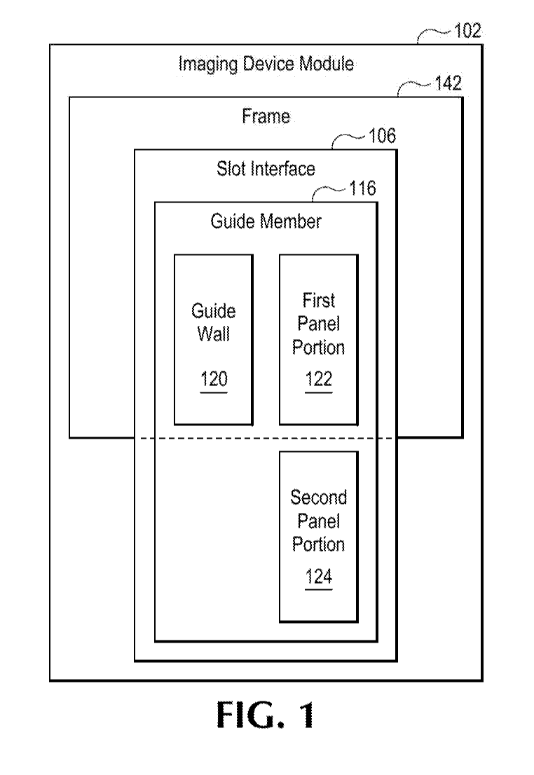

FIG. 1 is a block diagram of an example imaging device module 102. A slot interface 106 is fixedly coupled to a frame 142. The slot interface 106 comprises a guide member 116 that forms part of a channel. The guide member 116 includes a guide wall to guide a bracket in the channel as discussed further herein, a first panel portion substantially parallel to and in contact with the frame 142, and a second panel portion defining an aperture and not directly in contact with the frame 142.

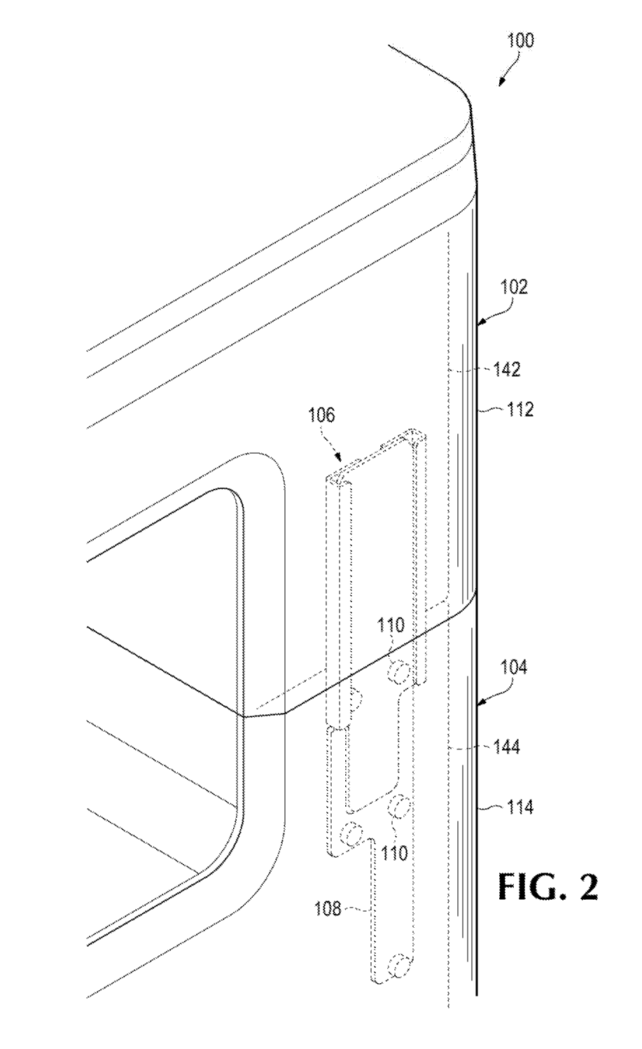

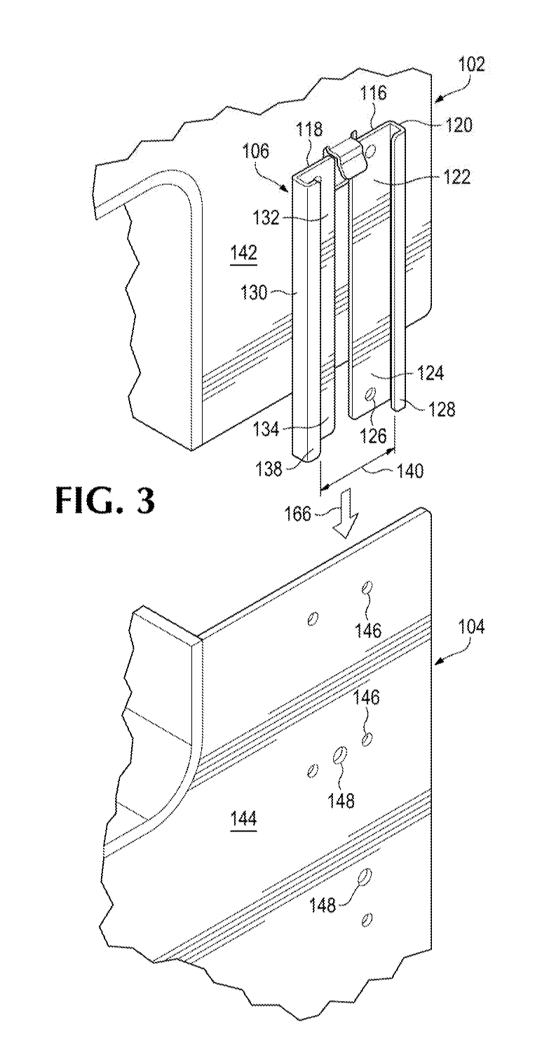

FIG. 2 is a perspective view of an example system 100 of assembled example imaging device modules 102 and 104. FIG. 2 depicts the components of a slot and bracket attachment as hidden underneath the cosmetic covers 112 and 114. In general, the components of the slot and bracket attachment approach include a slot interface 106, a bracket 108, and a fastener 110 (e.g., multiple fasteners are shown in FIG. 2). The covers 112 and 114 are shown on device modules 102 and 104, respectively, with the components of the slot and bracket attachment approach shown in dotted lines underneath the covers 112 and 114. In this manner, the form of the attachment is not visible to the end user because the cosmetic upper cover 112 and the cosmetic lower cover 114 conceal the attachment components connecting the structural frames of the modules 102 and 104. For example, the cover 112 may be attached to a frame 142 to conceal a portion of the slot interface 106 (e.g. a portion of a guide member of the slot interface 106) and expose a portion of the slot interface 106 (e.g., an entry at an end of the slot interface 106 as discussed with reference to FIG. 3), and the cover 114 may conceal the rest of the slot interface 106 not concealed by the cover 112. The covers 112 and 114 may be removable or otherwise movable away from the attachment site, such as an installation door on a hinge, to allow for access to the attachment site on the frame.

FIGS. 3-5 are perspective views of example assembly states of an example system 100. FIG. 3 is an example initial alignment state in which a first frame 142 of first device module 102 is being aligned with a second frame 144 of a second device module 104. As used herein, a frame is a physical support structure of a device module and may be able to bear moments (e.g., forces) on the device module. The slot interface 106 is fixedly coupled to the first frame 142. The slot interface 106 may be connected to the frame 142 in any appropriate manner (such as fasteners or a rivet-less joining system) that generates a fixed coupling between the slot interface 106 and the frame 142. The connection may be rigid so that any moment carries as directly as possible through the slot interface 106. For example, a portion of a guide member 116 may be securely fastened to the frame 142 based on mating contours, such as contours formed by a rivet-less joining system. The directness of the connection of the slot interface 106 to the frame 142 may, for example, improve the likelihood that a moment is transferred to the base module via the slot and bracket connection.

The slot interface 106 generally includes a guide member that forms part of a channel. Referring to FIG. 3, the slot interface 106 includes two guide members 116 and 118. The guide members generally include a guide wall, a portion in contact with the frame, and a portion not in contact with the frame. For example, the guide member 116 includes a guide wall 120, a first panel portion 122 in contact with the frame 142, a second panel portion 124 extending passed the frame 142 and defining an aperture 126. The first panel portion 122 and the second panel portion 124 may be substantially parallel to the frame 142 and may be portions of the same panel. The guide member 116 of FIG. 3 includes a third panel portion 128 that is opposite the first panel portion. The guide member 118 includes a guide wall 130, a first panel portion 132, a second panel portion 134, and a third panel portion 138 that are similar to (and correspond with) the components of the guide member 116.

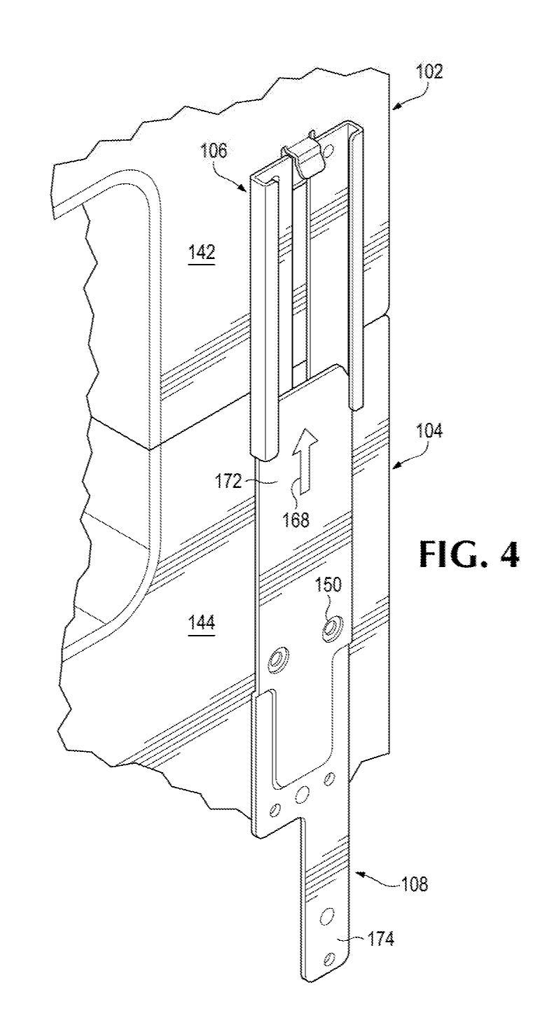

Referring to FIG. 3, the guide members 116 and 118 define a channel. The front panel portion 128 and the back panel (including portions 122 and 124 in FIG. 3) define boundaries to a channel while the distance 140 between the guide walls 120 and 130 further define boundaries to the channel. For example, the panel portions 122, 124, 132, and 134 define a frame-facing side of the channel, the guide walls 130 and 120 define side walls substantially perpendicular to the frame surface, the panels 128 and 138 define a side of the channel facing away from the frame 142, and corresponding ends of those components form an entry of the channel at an end of the slot interface 106 which is located vertically below the first frame as shown in FIG. 3. In this manner, a bracket may be placed in the slot interface through an entry at the portion of slot interface 106 that extends beyond the frame 142 as depicted by FIG. 4.

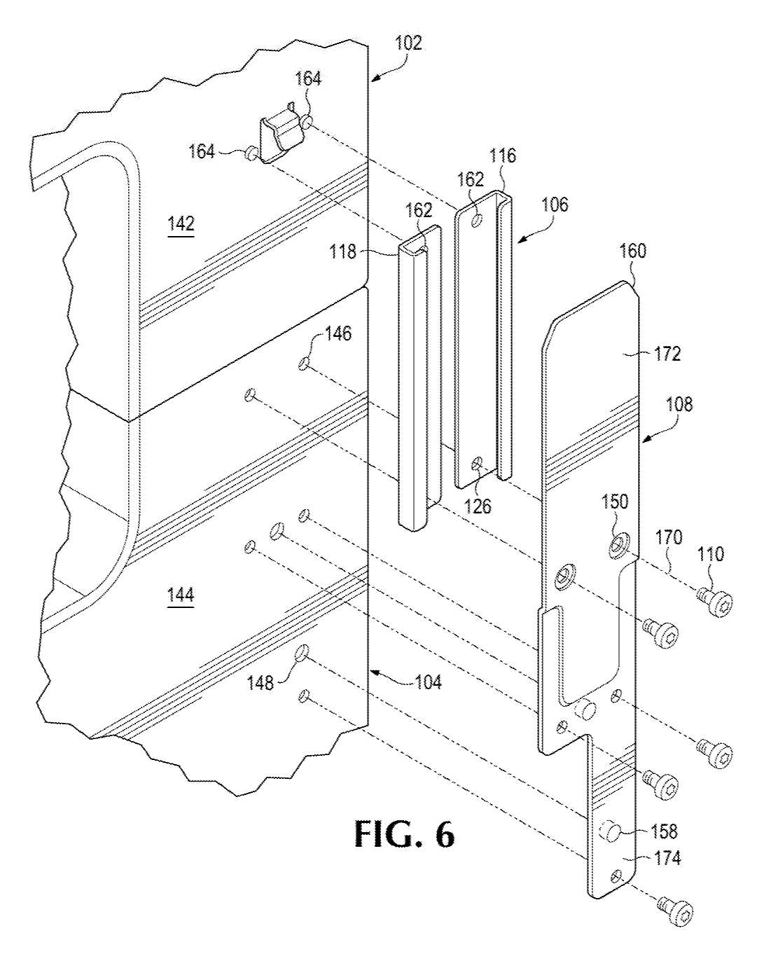

The device module 102 is aligned and placed adjacent to the device module 104 in the direction of arrow 166 so that the frames 142 and 144 are aligned. For example, the aperture 126 of FIG. 3 may align with an aperture of the frame 144. Other alignment features, such as features 148 of FIG. 3 may designate locations to match the attachment components so that the bracket and slot interface properly align with the frames to transfer a moment. Alignment of the slot and bracket attachment components is discussed further with respect to FIG. 6.

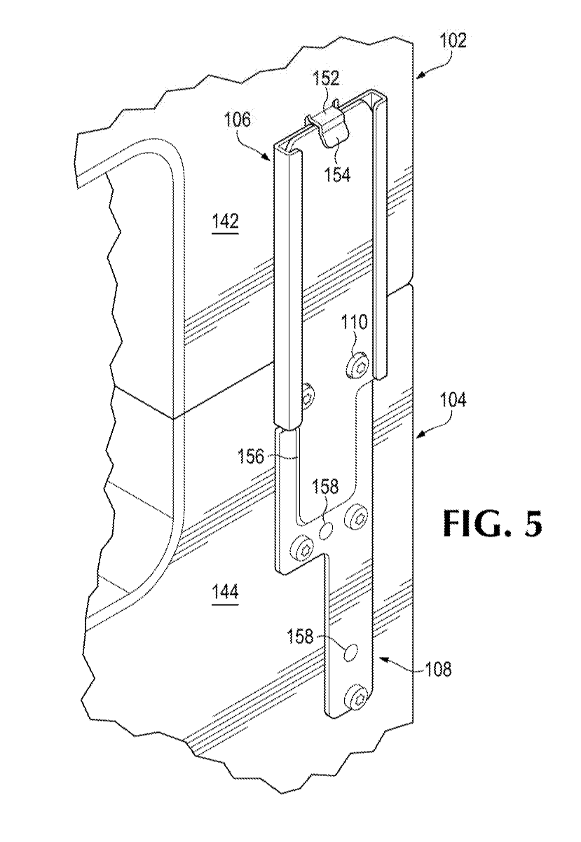

FIG. 4 depicts the imaging system 100 with the components of a slot and bracket attachment approach in an example bracket installation state. Referring to FIG. 4, the frames 142 and 144 of the modules 102 and 104 respectively, are abutted and aligned to be flush on a surface. A bracket 108 is aligned with the slot interface 106 and may be pushed into the channel of the slot interface 106 in the direction of arrow 168. The bracket 108 may be oriented at an angle to the surface of the frame 144 during insertion into the slot interface 106, for example, to allow for the bracket 108 to pass by protruding alignment features. A first portion of the bracket 108 may be flat (such as the blade 172), tubular, or otherwise compatible with the slot interface (e.g., structured to snuggly fit in the channel of the slot interface) and a second portion of the bracket 108 may define an aperture 150 to assist fastening the bracket 108 to the slot interface 106 as shown in FIG. 5.

FIG. 5 depicts the imaging system 100 with the components of a slot and bracket attachment approach in a fastened state. Referring to FIG. 5, the bracket 108 may slide into the slot interface 106 until an end cap 152 is reached at an end of the slot interface 106, where the end cap 152 may include a tab 154 to assist alignment of a projecting portion at an end of the slot interface 106. For example, the end cap 152 may be a wall extending perpendicular from the frame-facing surface of the slot interface 106 to limit a distance of the bracket 108 along the channel of the slot interface 106 and the tab 154 may define a first surface that is tapered to assist contact of a second surface of the first portion of the bracket 108. The end cap 152 and tab 154 may be part of the slot interface and/or the frame. The bracket 108 may be aligned to an appropriate location in the slot interface 106 and/or an appropriate location on the frame 144. For example, the bracket 108 may include alignment features 158 to assist orientation of the bracket 108. The bracket 108 may include a contour surface, such as contour 158 to allow the bracket to properly contact a surface of the frame 144 as well as a surface of the slot interface 106 so that the bracket 108 may be flush with both the slot interface 106 and the frame 144 at the same time (e.g., during a fastened state). The bracket 108 is fastened by to the slot interface 106 and/or the base device module frame 144. In the example of FIG. 5 and as shown in more detail in FIG. 6, the fastener 110 connects the bracket 108 to both the slot interface 106 and the frame 144 of device module 104. In this manner, the modules 142 and 144 are connected via the slot and bracket combination.

FIG. 6 is an exploded view of example components of an example system of example imaging device modules 102 and 104. The example system 100 of FIG. 6 generally includes an upper device module 102, a lower device module 104, a bracket 108, and a fastener 110. Other example systems may include any appropriate number of the components in accordance with the desired model and the desired security of the attachment between modules. For example, the system 100 of FIG. 5 includes five fasteners 110 to attach the slot and bracket attachment components to the frame 144.

In the example of FIG. 6, the slot interface 106 is composed of a plurality of guide members (e.g., 116 and 118 of FIG. 5) fixedly coupled to the frame 142. In other examples, the slot interface may be composed of a single guide member with panels and guide walls integrated into the single guide member to define a channel to receive the bracket. The slot interface 106 may include an aperture 126 on a portion of the slot interface that extends passed the frame 142. In the example of FIG. 6, the slot interface 106 includes multiple apertures 126 that extend passed the upper frame 142 that correspond with apertures 146 in the lower frame 144. The lower frame 144 may include apertures 146 a different portions of the lower frame 144 to allow for the bracket 108 to be fastened at those locations of the lower frame 144.

Referring to FIG. 6, the bracket 108 includes a first portion at a first end of the bracket (e.g., the blade 172) and a second portion that defines an aperture 150. The first portion slidably fits in the channel defined by the slot interface 106. In the example of FIG. 6, the aperture 150 defined by the second portion corresponds to an aperture 146 of the lower frame 144 and the aperture 126 of the slot interface 106. A fastener 150 couples the bracket 108, the slot interface 106, and the lower frame 144 at the apertures 126, 146, and 150 as depicted by line 170. In other examples, the first frame 142 and second frame 144 may overlap and the fastener 110 may secure the bracket and the slot interface to both the first frame and the second frame along the same line.

Alignment features may be provided in the components of the slot and bracket attachment approach that correspond to alignment features on the frames to assist in alignment of the components and device modules during assembly. As used herein, an alignment feature includes any structural characteristic that identifies a location. Example alignment features include protrusions, projections, indents, apertures, or other structural profiles that may have corresponding contours with another alignment feature. In this manner, an alignment feature may have a matching alignment feature to indicate when a component of the slot and bracket attachment is in a proper orientation and/or location. The upper device module 102 of FIG. 6 includes an upper frame 142 with a plurality of alignment features 164 to align with a corresponding plurality of alignment features 162 of the slot interface 106. For example, the upper frame 142 may include a first and second alignment feature 164 on the surface of the frame 142 where the guide members 116 and 118 include portions that define alignment features 162 corresponding to the first and second alignment features 164 on the upper frame 142. The lower device module 104 of FIG. 5 includes lower frame 144 may have a plurality of alignment features 148 corresponding to a plurality of alignment features 158 of the bracket 108. For example, a first and second alignment features 158 may be offset to provide proper orientation of the bracket 108 to allow for the apertures 126, 146, and 150 to line up (as indicated by line 170 of FIG. 6) and allow fastener 110 to secure the components together.

The bracket 108 may include a blade (e.g., bracket portion 172) with tapered corners 160 at the end of the blade to assist insertion of the blade into the channel of the slot interface 106. The bracket 108 may include a contour where the blade portion 172 and the handle portion 174 are offset by a width of a frame-facing panel of the slot interface 106. The bracket 108 may be fastened to the slot interface 106 at about the midpoint of the bracket 108 and may also be fastened to the lower frame 144 at other locations to ensure secure fastening of the bracket 108 to the lower frame 144. The locations of fasteners 110 to secure the bracket 108 may be arranged based on the expected moment and/or desired transfer of moment by the slot and bracket attachment.

No specific indication of attachment of the slot interface 106 to the upper frame 142 is shown in FIG. 6. Any number of fastening techniques may be used. For example, the guide members 116 and 118 may be securely fastened to the upper frame 142 by screws or a rivet-less technique. The degree of fastening of the slot interface 106 and the bracket 108 to the frames 142 and 144 may affect, for example, factors such as complexity of assembly and likelihood of a transfer of a possible moment.

In the example slot and bracket attachment approach depicted in FIGS. 1-6, the bracket 108 is fastened to the lower frame 144 and is not fastened directly to the upper frame 142. For example, the first portion of the bracket (e.g. the blade 172) is only connected to the first frame via the slot interface by a plurality of guide members, the end cap, and/or the tab. Because the portion of the bracket 108 that is fastened with fasteners does not overlap the first frame (e.g., overlaps only the second frame), the cover of the device module 102 (e.g., cosmetic cover 112 of FIG. 2) may be left on during installation of the bracket 108 and otherwise during completion of the assembly of the device modules together to complete the system 100. In this manner, assembly time may be reduced, for example, as well as allowing an orientation of the modules to allow for moment to be compensated for, even though the lower device module 104 and the upper device module 102 are not directly fastened, but are fastened indirectly via a bracket and slot interface connection.

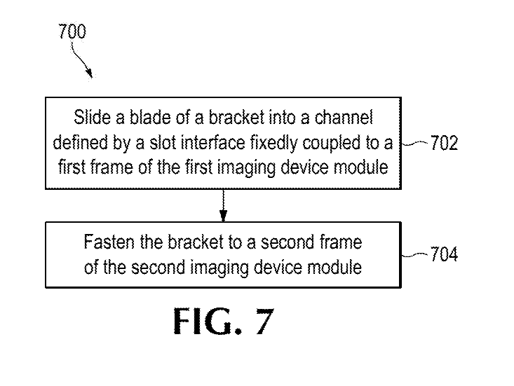

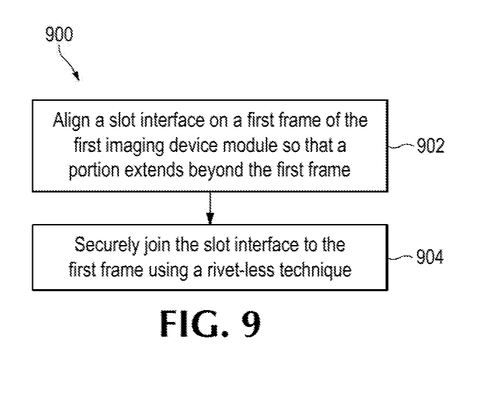

The components discussed herein may be made of sheet metal, plastic, or other structurally appropriate material. In some examples, functionalities described herein in relation to any of FIGS. 1-6 may be provided in combination with functionalities described herein in relation to any of FIGS. 7-9.

FIGS. 6-8 are flow diagrams depicting example methods 600, 700, and 800 of connecting a first imaging device module to a second imaging device module. Referring to FIG. 6, example method 600 of connecting a first imaging device module to a second imaging device module may generally comprise sliding a bracket into a slot interface fixedly coupled to the first imaging device module and fastening the bracket to the second imaging device module.

At block 602, a blade of a bracket is slid into a channel defined by a slot interface that is fixedly coupled to the frame of the first imaging device module. The blade of the bracket may be slid into the channel while a cosmetic cover is installed on the first imaging device module. In that example, assembly time may be saved by not having to take off the cover of the first imaging device module. At block 604, the bracket is fastened to the frame of the second imaging device module. Though the bracket may not be directly fastened to the first frame, the bracket is able to transfer moment from the first frame via the slot interface and to the second frame via the direct fastening to the second frame. The cover of the second imaging device module may be removed (e.g., an installation door on the cosmetic cover of the device module is opened) to slide in and fasten the bracket and then reapplied (e.g., the installation door is closed) after the assembly is completed. In this manner, only the cover of the second imaging device module is manipulated and not the cover of the first imaging device module to perform the assembly of the first and second imaging device modules.

FIG. 7 includes blocks similar to blocks of FIG. 6 and provides additional blocks and details. In particular, FIG. 7 depicts additional blocks and details generally regarding aligning the bracket and fastening the bracket to the slot interface. Blocks 702 and 708 of method 700 are similar to blocks 602 and 604 of FIG. 6 and, for brevity, their respective descriptions are not repeated. At block 704, the bracket is aligned using a first plurality of alignment features on the bracket corresponding to a second plurality of alignment features on the frame of the second imaging device module. At block 706, the bracket is fastened to the slot interface. The fastening of blocks 706 and 708 may be performed using the same fastener, such as depicted with regards to FIG. 5, so that the second frame, the slot interface, and the bracket are secured together using a fastener.

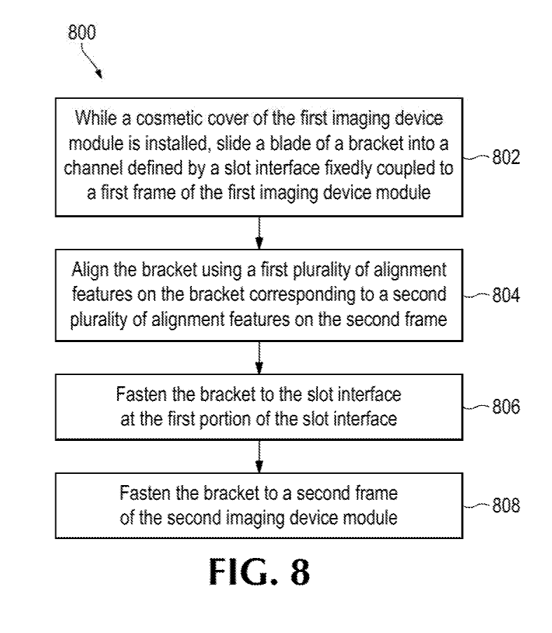

FIG. 8 is an example method 800 of connecting a first imaging device module to a second imaging device module that generally includes aligning the slot interface on the first imaging device module and securing the slot interface to the first imaging device module. At block 802, the slot interface is aligned on a frame of the first imaging device module. The slot interface may be aligned using alignment features. The slot interface may be aligned so that a portion of the slot interface extends beyond the first frame (e.g., and extends onto a second frame with reference to the second frame of the second imaging device module when the modules are aligned and placed adjacent to the first imaging device module). At block 804, the slot interface is securely joined to the frame of the first imaging device module. For example, the slot interface may be securely joined to the frame of the first imaging device module using a rivet-less technique where force is applied to the surfaces of the slot interface and the frame of the first imaging device module so that they are modified to having mating contours that are secured together due to the shape of the contours. The methods 600 or 700 may follow the method 800 to complete the assembly operations of an imaging device, such as a multifunction printer.

Although the flow diagrams of FIGS. 6-8 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present description.

All of the features disclosed in this specification (including any accompanying claims, abstract and drawings), and/or all of the elements of any method or process so disclosed, may be combined in any combination, except combinations where at least some of such features and/or elements are mutually exclusive.

The present description has been shown and described with reference to the foregoing examples. It is understood, however, that other forms, details, and examples may be made without departing from the spirit and scope of the following claims. The use of the words “first,” “second,” or related terms in the claims are not used to limit the claim elements to an order or location, but are merely used to distinguish separate claim elements.

What is claimed is:

1. An imaging device module comprising:
a frame;
a slot interface fixedly coupled to the frame, the slot interface comprising:
a first guide member to form part of a channel, the first guide member comprising:
a first guide wall;
a first panel portion substantially parallel to and in contact with the frame; and
a second panel portion defining a first aperture, the second panel portion not in contact with the frame.

2. The imaging device module of claim 1, wherein the slot interface comprises a second guide member comprising:
a second guide wall;
a third panel portion substantially parallel to and in contact with the frame; and
a fourth panel portion coupled to the first panel portion, the second panel portion not in contact with the frame and defining a second aperture.

3. The imaging device module of claim 2, wherein:
the first guide member further comprises a fifth panel portion opposite the first panel portion;
the second guide member further comprises a sixth panel portion opposite the third panel portion;
the first panel portion, the second panel portion, the third panel portion, and the fourth panel portion defining a frame-facing side of the channel defined by the first guide member and the second guide member; and
the first guide member and the second guide member forming an entry of the channel at a first end of the slot interface.

4. The imaging device module of claim 3, comprising:
an end stop at a second end of the slot interface; and
a cover member attached to the frame, the cover member to conceal the first panel portion of the first guide member and the third panel portion of the second guide member and expose the entry at the first end of the slot interface.

5. The imaging device module of claim 3, wherein:
the first panel portion and the third panel portion are securely fastened to the frame based on mating contours.

6. The imaging device module of claim 3, wherein:
the frame further comprises a first alignment feature on the surface of the frame and a second alignment feature on the surface of the frame;
the first panel portion of the first guide member defines a third alignment feature corresponding the first alignment feature of the frame; and
the third panel portion of the second guide member defines a fourth alignment feature corresponding to the second alignment feature of the frame.

7. A system comprising:
a first device module comprising
a first frame; and
a slot interface fixedly coupled to the first frame, the slot interface comprising:
a plurality of guide members defining a channel, a first guide member of the plurality of guide members having a portion defining a first aperture;
a second device module comprising:
a second frame having a frame portion defining a second aperture corresponding to the first aperture;
a bracket comprising:
a first portion at a first end of the bracket, the first portion to slidably fit in the channel; and
a second portion that defines a third aperture corresponding to the second aperture; and
a first fastener coupling the bracket, the slot interface, and the second frame at the first aperture, the second aperture, and the third aperture.

8. The system of claim 7, wherein:
the first frame has a first plurality of alignment features corresponding to a second plurality of alignment features on the slot interface; and
the second frame has a third plurality of alignment features corresponding to a fourth plurality of alignment features of the bracket.

9. The system of claim 7, wherein:
the bracket fastened to the second frame at a third portion at a second end of the bracket using a second fastener; and
the slot interface is attached to the first frame using a rivet-less technique.

10. The system of claim 9, wherein:
the first portion of the bracket comprises a blade, the blade having tapered corners at the first end of the bracket to assist insertion into the channel;
the first portion of the bracket and the third portion of the bracket are offset by a width of a surface of the slot interface; and
the third aperture of the bracket is located at about the midpoint of the bracket.

11. The system of claim 7, further comprising:
an end stop to limit distance of the bracket along the channel; and
a tab defining a first surface that contacts a second surface of the first portion of the bracket, the first surface being tapered.

12. The system of claim 11, wherein:
the first portion of the bracket is only connected to the first frame via the slot interface by the plurality of guide members, the end cap, and the tab; and
the second portion of the bracket overlaps only the second frame.

13. A method of connecting a first imaging device module and a second imaging device module comprising:
sliding a blade of a bracket into a channel defined by a slot interface fixedly coupled to a first frame of the first imaging device module; and
fastening the bracket to a second frame of the second imaging device module.

14. The method of claim 13, further comprising:
aligning the bracket using a first plurality of alignment features on the bracket corresponding to a second plurality of alignment features on the second frame; and
fastening the bracket to the slot interface.

15. The method of claim 14, further comprising:
aligning the slot interface on the first frame of the first imaging device module, the slot interface comprising a first portion that extends beyond the first frame;
securely joining the slot interface to the first frame using a rivet-less technique,
wherein:
the sliding the blade of the bracket into the channel occurs while a cover of the first imaging device module is installed; and
the fastening the bracket to the second frame and the fastening the bracket to the slot interface are performed using the same fastener.
